(19) United States
(12) Patent Application Publication
(10) Pub. No.: US 2024/0381496 A1
(43) Pub. Date: Nov. 14, 2024

(54) INDUCTION COOKTOP ASSEMBLY

(71) Applicant: WHIRLPOOL CORPORATION, BENTON HARBOR, MI (US)

(72) Inventor: Mayuresh Chandulal Neve, Pune (IN)

(73) Assignee: WHIRLPOOL CORPORATION, BENTON HARBOR, MI (US)

(21) Appl. No.: 18/657,290

(22) Filed: May 7, 2024

Related U.S. Application Data
(60) Provisional application No. 63/465,574, filed on May 11, 2023.

(51) Int. Cl. H05B 6/12; H05B 6/06

(52) U.S. Cl. CPC H05B 6/1245; H05B 6/062; H05B 2206/022

(57) ABSTRACT

An induction cooktop assembly includes a cooktop surface that extends between a first end of the induction cooktop assembly to a second end of the cooktop assembly. A first induction coil corresponds to a first heat zone of the induction cooktop assembly. A second induction coil corresponds to a second heat zone of the induction cooktop assembly. A circuit board is below the first and second induction coils. A first set of electrical components electrically couples with the circuit board and is configured to control the first induction coil. A second set of electrical components electrically couples with the circuit board and is configured to control the second induction coil. The first set of electrical components is nearer to the second induction coil than the second set of electrical components is to the second induction coil and vice versa for the second set of electrical components.

### CROSS-REFERENCE TO RELATED APPLICATIONS

This application claims priority to U.S. Provisional Patent Application No. 63/465,574, filed on May 11, 2023, entitled “INDUCTION COOKTOP ASSEMBLY,” the disclosure to which is hereby incorporated herein by reference in its entirety.

### BACKGROUND OF THE DISCLOSURE

The present disclosure generally relates to an induction cooktop assembly, and more specifically, to an arrangement of electronic components and induction coils for a cooktop assembly of a cooktop appliance.

### SUMMARY OF THE DISCLOSURE

According to one aspect of the present disclosure, an induction cooktop assembly includes a cooktop surface that extends between a first end of the induction cooktop assembly to a second end of the cooktop assembly opposite the first end. The induction cooktop assembly includes a first induction coil corresponding to a first heat zone of the induction cooktop assembly. The induction cooktop assembly further includes a second induction coil corresponding to a second heat zone of the induction cooktop assembly. The induction cooktop assembly further includes a circuit board disposed below the first and second induction coils. The induction cooktop assembly further includes a first set of electrical components electrically coupled with the circuit board and configured to control the first induction coil. The induction cooktop assembly further includes a second set of electrical components electrically coupled with the circuit board and configured to control the second induction coil. The first set of electrical components is nearer to the second induction coil than the second set of electrical components is to the second induction coil. The second set of electrical components is nearer to the first induction coil than the first set of electrical components is to the first induction coil.

According to another aspect of the present disclosure, a cooking appliance includes a first induction coil corresponding to a first heat zone, a second induction coil corresponding to a second heat zone, a circuit board disposed below the first and second induction coils, a first set of electrical components electrically coupled with the circuit board and configured to control the first induction coil, and a second set of electrical components electrically coupled with the circuit board and configured to control the second induction coil, wherein the first set of electrical components is nearer to the second induction coil than the second set of electrical components is to the second induction coil, and wherein the second set of electrical components is nearer to the first induction coil than the first set of electrical components is to the first induction coil. According to another aspect of the present disclosure, an induction cooktop assembly includes a cooktop surface that extends between a first end of the induction cooktop assembly to a second end of the cooktop assembly opposite the first end, a first induction coil corresponding to a first heat zone of the induction cooktop assembly, a second induction coil corresponding to a second heat zone of the induction cooktop assembly, a circuit board disposed below the first and second induction coils, a first set of electrical components electrically coupled with the circuit board and configured to control the first induction coil, and a second set of electrical components electrically coupled with the circuit board and configured to control the second induction coil, wherein the first set of electrical components is nearer to the second induction coil than the second set of electrical components is to the second induction coil, wherein the second set of electrical components is nearer to the first induction coil than the first set of electrical components is to the first induction coil, and wherein the first and second sets of electrical components are disposed on a common substrate of a printed circuit board (PCB) disposed below the first and second induction coils.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top perspective view of an induction cooking appliance according to one aspect of the present disclosure;

FIG. 2 is a top perspective view of the induction cooktop appliance of FIG. 1 with a cover plate removed from the induction cooking appliance;

FIG. 3 is a cross-sectional view of the induction cooking appliance of FIG. 1 taken along the lines III-III;

FIG. 4 is a top plan view of an induction cooktop assembly of the induction cooking appliance of FIG. 1 with a support plate for induction coils of the induction cooktop assembly removed;

FIG. 5 is a schematic view of electrical connections between a circuit board of the induction cooktop assembly and a pair of induction coils of the induction cooktop assembly; and

FIG. 6 is an electrical schematic of exemplary induction circuits employed for first and second induction coils of an induction cooktop assembly according to one aspect of the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to an induction cooktop assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

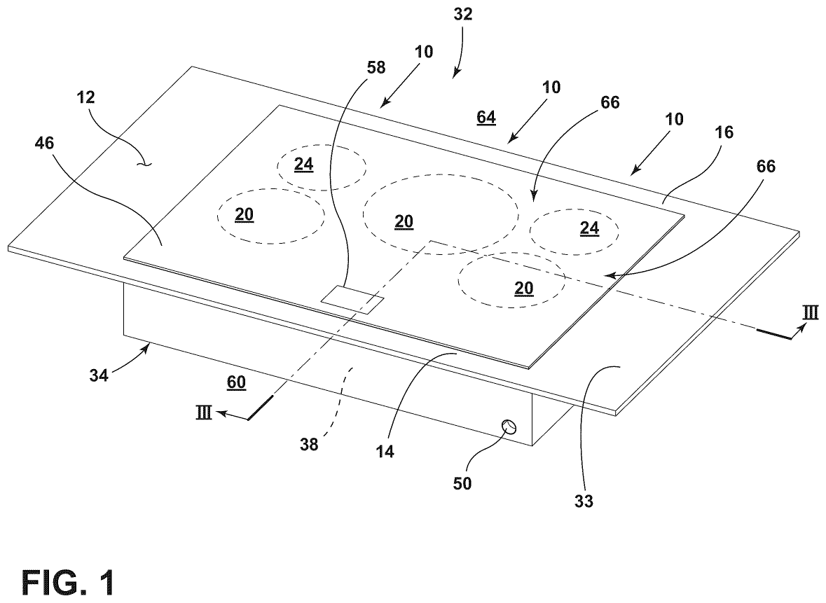

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-6, reference numeral 10 generally designates an induction cooktop assembly 10 that includes a cooktop surface 12 that extends between a first end 14 of the induction cooktop assembly 10 to a second end 16 of the induction cooktop assembly 10 opposite the first end 14. The induction cooktop assembly 10 includes a first induction coil 18 corresponding to a first heat zone 20 of the induction cooktop assembly 10. The induction cooktop assembly 10 includes a second induction coil 22 corresponding to a second heat zone 24 of the induction cooktop assembly 10. A circuit board 26 is disposed below the first and second induction coils 18, 22. A first set of electrical components 28 is electrically coupled with the circuit board 26 and configured to control the first induction coil 18. A second set of electrical components 30 is electrically coupled with the circuit board 26 and configured to control the second induction coil 22. The first set of electrical components 28 is nearer to the second induction coil 22 than the second set of electrical components 30 is to the second induction coil 22. The second set of electrical components 30 is nearer to the first induction coil 18 than the first set of electrical components 28 is to the first induction coil 18.

Referring to FIGS. 1-4, the induction cooktop assembly 10 may be part of an induction cooking appliance 32 that incorporates one or more of the induction cooktop assemblies 10 (e.g., three cooktop assemblies 10). While two of the three cooktop assemblies 10 (the cooktop assemblies 10 on the right and left of the cooking appliance 32) are illustrated as including two induction coils 18, 22 each, it is contemplated that any plurality of induction coils 18, 22 may be incorporated in a single cooktop assembly 10. Further, as demonstrated by the central cooktop assembly 10, a cooktop assembly 10 may include a single induction coil 18. The induction cooking appliance 32 may be a stand-alone cooktop appliance for a countertop 33 in a kitchen environment. In some examples, the induction cooking appliance 32 is part of another kitchen appliance, such as a range having an oven below the induction cooktop assembly 10. In some examples, the induction cooking appliance 32 includes a single cooktop assembly 10 (e.g., a single printed circuit board (PCB)) for driving the induction coils.

Still referring to FIGS. 1-4, the induction cooking appliance 32 may be installed in a cabinet 34, such as a kitchen cabinet. The countertop 33 defines an opening 36 that allows access to a cavity 38 formed by the cabinet 34 for installation of the cooking appliance 32 in the countertop 33/cabinet 34. A cover plate 46 is operably coupled with the countertop 33 and extends over the opening 36. The cover plate 46 forms the cooktop surface 12 on the outside of the cooking appliance 32 and has an inner surface facing the induction coils 18, 22. The cover plate 46 may incorporate a ceramic layer (e.g., glass) that resists heat and corrosion. For example, the ceramic layer of the cover plate 46 may limit heat distribution on the cooktop surface 12 to the heat zones 20, 24.

Still referring to FIGS. 1-4, one or more conduits 50 may extend through the cabinet 34 to provide electrical power to the induction cooking appliance 32. For example, the induction cooking appliance 32 may be provided with a power cable configured to provide electrical power (e.g., alternating-current voltage, or VAC) for powering each induction cooking appliance 32. For example, a conventional voltage, such as between 110 and 120 VAC or between 220 and 240 VAC may be supplied to the induction cooking appliance 32 under the cooktop surface 12.

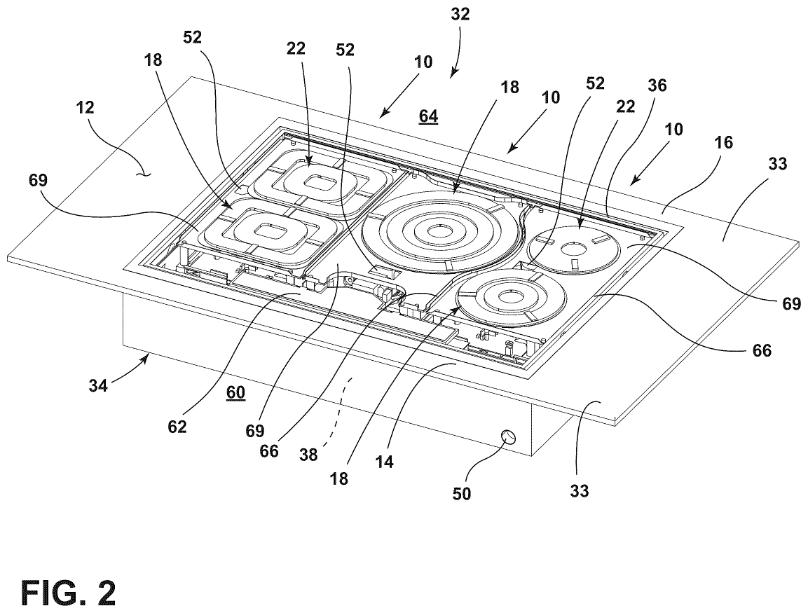

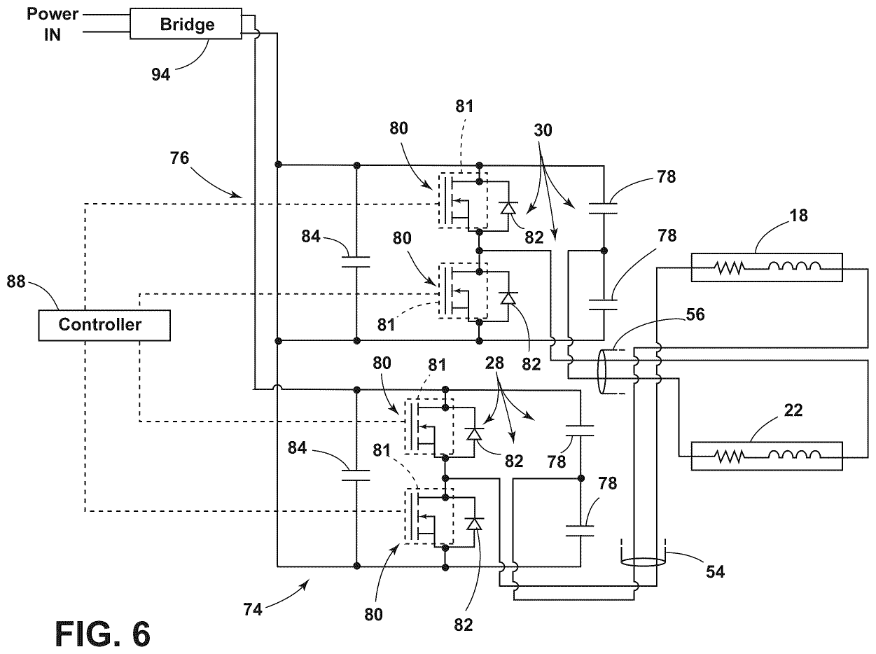

Referring more particularly to FIG. 2, each support plate 69 may define at least one aperture 52 to allow an electrical cable or electrical conductors to extend between the circuit board 26 and the first and second induction coils 18, 22. For example, as will be described with respect to FIG. 6, electrical connectors 54, 56 may extend between the circuit board 26 and each induction coil 18, 22 of the cooktop assembly 10. Accordingly, each cooktop assembly 10 may include a first electrical connection and a second connection.

Still referring to FIG. 2, the induction cooking appliance 32 includes an interface 58 near a front 60 of each cooktop assembly 10, or the cooking appliance 32, for controlling the induction coils 18, 22 of each cooktop assembly 10. The interface 58 may include an interface circuit board 62 coupled with the cover plate 46. A portion of the cover plate 46 may overlay the interface 58 and be touch-sensitive to allow a user to interact with the interface circuit board 62 via a human-machine interface (HMI) or other interface at the induction cooking appliance 32. The interface circuit board 62 is in electrical communication with the circuit board 26 for each cooktop assembly 10 to allow the induction coils 18, 22 to be controlled via the interface 58.

It is contemplated that the first and second ends 14, 16 of the cooktop assembly 10 previously described may refer to a back 64 of the cooktop assembly 10 (or the induction cooking appliance 32) and the front 60 of the cooking appliance 32. However, the ends 14, 16 of the cooktop assembly 10 may alternatively refer to opposing lateral sides 66 of the cooktop assembly 10, such as the example in which two heat zones 20, 24 are placed side-by-side and are above the interface circuit board 62.

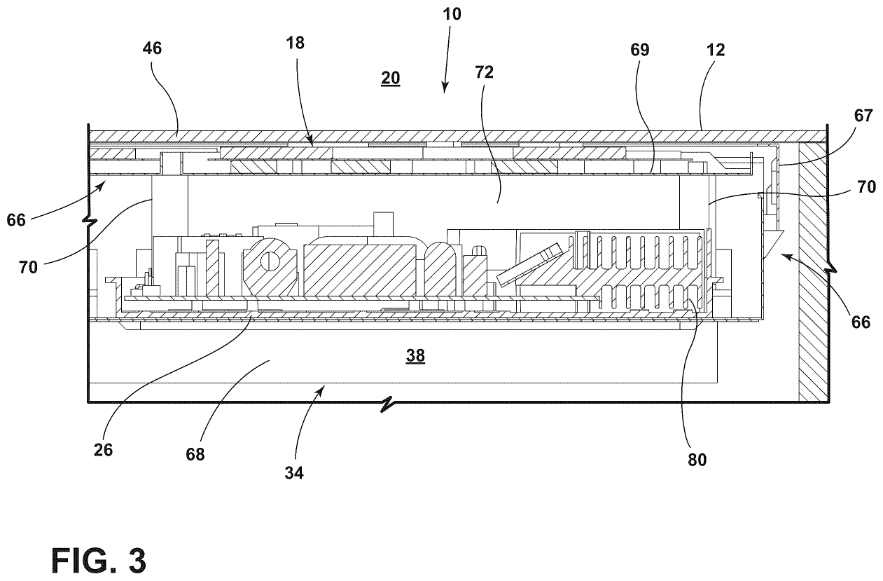

Referring now to FIGS. 2 and 3, the induction cooking appliance 32 may include an inner housing 67 coupled with and suspending from the cabinet 34. The inner housing may be spaced from the cabinet 34 below the inner housing 67 to provide a chamber 68 between the inner housing 67 and the cabinet 34 in which the conduit 50 extends. The circuit board 26 for each cooktop assembly 10 is disposed in the inner housing 67 and is spaced from a support plate 69 that holds the first and second induction coils 18, 22 for the cooktop assembly 10. For example, spacers 70 are provided between the circuit board 26 and the support plate 69 to provide a space 72 above the circuit board 26 and below the first and second induction coils 18, 22. As will be described further herein, the space 72 may be heated via heat dissipation from electrical devices on the circuit board 26 and heat dissipation from the first and second induction coils 18, 22. The present induction cooktop assembly 10 may thermally manage the space 72, and therefore the induction cooktop assembly 10, by providing an enhanced arrangement of the electrical devices relative to the first and second induction coils 18, 22 and underneath or below the first and second induction coils 18, 22. In this way, excessive temperature conditions may be reduced.

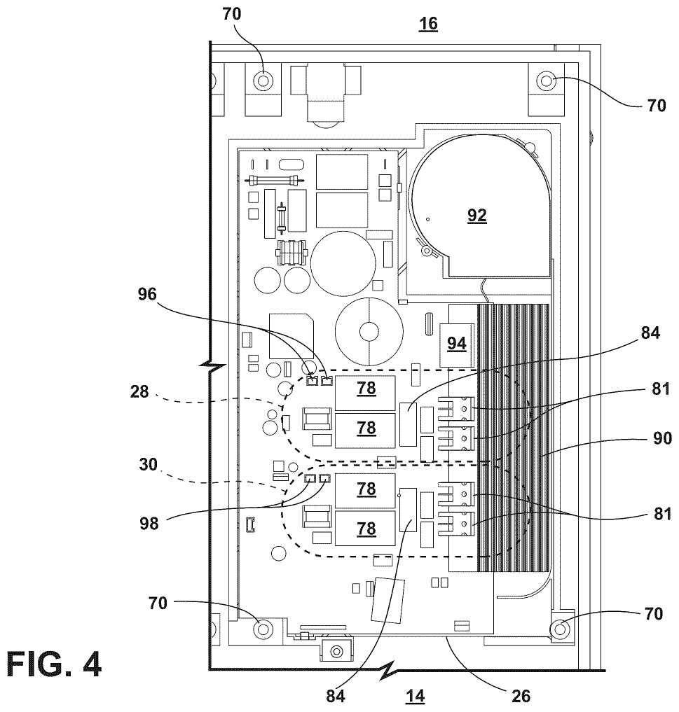

Referring now to FIGS. 4-6, a pair of induction circuits 74, 76 for the induction cooktop assembly 10 may be implemented via the first and second induction coils 18, 22 and various electrical devices on the circuit board 26. For example, the first induction circuit 74 includes the first set of electrical components 28, and the second induction circuit 76 includes the second set of electrical components 30. Each set of electrical components 28, 30 includes a pair of resonant capacitors 78 and a pair of switching devices 80, such as transistors, for controlling the electrical current through the respective induction coil 18, 22. For example, the switching devices 80 may be insulated-gate bipolar transistors (IGBT) 81. In electrical parallel with each switching device 80 is a free-wheeling diode 82 (FIG. 6). A direct-current (DC) smoothing capacitor 84 may be provided for each induction circuit 74, 76 to smooth electrical power in each of the first and second induction circuits 74, 76.

The various electrical devices may include inductors, capacitors, and any other power electronics disposed on a substrate 86 common to the first and second sets of electrical components 28, 30. For example, the circuit board 26 may be a printed circuit board 26 mounted to the inner housing 67 and including one more conductive tracing. As will be described further with respect to FIG. 6, a controller 88 may control the first and second induction circuits 74, 76 and may be disposed on or separate from the circuit board 26. For example, the controller 88 may be coupled with the interface circuit board 26.

A heat sink 90 is operably coupled with the circuit board 26 for removing heat from the space 72 and/or the circuit board 26. A blower 92 is arranged adjacent to the second end 16 of the cooktop assembly 10 and is configured to circulate air over the heat sink 90 and the circuit board 26 to cool the space 72. The switching devices 80 may be disposed proximate to the heat sink 90 and may be in-line with airflow from the blower 92 to enhance cooling of the switching devices 80. In addition, an electrical bridge device 94 may be provided for controlling or monitoring current in the circuit board 26. For example, the electrical bridge device 94 may convert alternating-circuit (AC) power into direct current (DC) power. The electrical bridge device 94 may be cooled via the circulation of air.

Because the switching devices 80 may be actively and quickly controlled between ON and OFF states hundreds or thousands of times per second, and because the resonant capacitors 78 may charge and discharge hundreds or thousands of times per second, the first and second switching devices 80 may generate heat within the space 72. In a like way, the first and second induction coils 18, 22 may generate heat that is dissipated from above the space 72 and into the space 72. Accordingly, the first and second sets of electrical components 28, 30 may be disposed adjacent opposite ends 14, 16 of the induction cooktop assembly 10 relative to the ends 14, 16 at which the first and second induction coils 18, 22 are disposed. Thus, while it may be logically intuitive to position the first induction circuit 74 nearer to the first induction coil 18 than the second induction circuit 76 is positioned relative to the first induction coil 18, and vice versa, the present arrangement positions the first induction circuit 74 nearer to the second induction coil 22 than the second induction circuit 76 is positioned relative to the second induction coil 22 (and vice versa). Stated in another way, the first induction circuit 74 may produce heat at the first end 14 of the induction cooktop assembly 10 when it energizes the first induction coil 18, and the first induction coil 18 may generate heat at the second end 16 of the induction cooktop assembly 10 when the first induction coil 18 is energized. By spacing the induction circuit 74, 76 from its corresponding induction coil 18, 22, the heat within the space 72 may be distributed more evenly and reduce high temperature spots in the space 72.

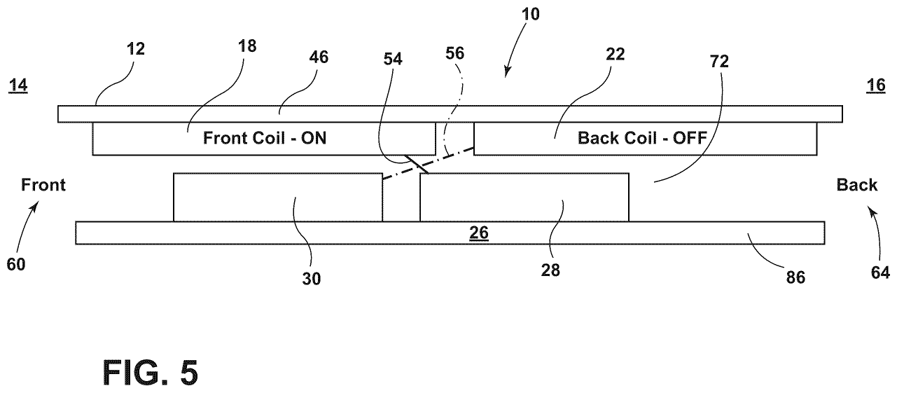

Referring more particularly to FIGS. 4 and 5, the first electrical connector 54 may electrically couple with a first socket 96 of the first induction circuit 74, and the second electrical connector 56 may electrically couple with a second socket 98 of the second induction circuit 76. The first and second sockets 96, 98 are electrically and operably coupled with the circuit board 26. The electrical connectors 54, 56 extend upwardly from the sockets 96, 98 and toward the aperture 52, or, in some examples, different apertures in a support plate 69, for electrical connection with the corresponding induction coil 18, 22. For example, each electrical connector 54, 56 may be a wire harness or other electrical cabling that may have heat shielding and may be fastened (via, e.g., wire ties) to a back surface of the support plate 69. In this way, the space 72 may allow the electrical connectors 54, 56 to be routed between the sockets 96, 98 and the induction coils 18, 22.

Referring now more particularly to FIG. 6, an example of the first and second induction circuits 74, 76 are shown with the respective first and second set of electrical components 28, 30. The controller 88 is in electrical communication with the switching devices 80 for controlling operation of the first and second induction coils 18, 22. For example, the controller 88 may selectively energize the switching devices 80 to open and close to generate a specific heat level for the first and second heat zones 20, 24. As demonstrated in FIG. 6, there is a logical/electrical connection between the first induction circuit 74 and the first induction coil 18, and a logical/electrical connection between the second induction circuit 76 and the second induction coil 22. However, as previously described, the present arrangement may enhance the thermal properties of the induction cooktop assembly 10 by, counterintuitively, spacing the first induction coil 18 from the first set of electrical components 28 and spacing the second induction coil 22 from the second set of electrical components 30.

In general, the present arrangement of the cooktop assembly 10 may increase durability and serviceability for the induction cooking appliance 32 with limited alterations to the design. The present arrangement may reduce the maximum temperature of the resonant capacitors 78 that are in use by up to 13° C. In some examples, in-use resonant capacitors 78 are in the range of 90-100° C. In some examples, the in-use resonant capacitors 78 are in the range of 90-97° C. Thermal properties of the switching devices 80 that are in use and the electrical bridge device 94 may further be reduced by between 2-4° C. In some examples, the insulated-gate bipolar transistor (IGBT) 81 that is in use is in the range of between 80-111° C. In some examples, the maximum temperature for the first and second sets of electronics 28, 30 may be below 110° C. when either the first or second induction coils 18, 22 are in use (e.g., one of the heat zones 20, 24 is being heated). Preferably, the maximum temperature for the first and second sets of electronics 28, 30 is below 109° C. during heating of one of the heat zones 20, 24.

According to one aspect of the present disclosure, an induction cooktop assembly includes a cooktop surface that extends between a first end of the induction cooktop assembly to a second end of the cooktop assembly opposite the first end. The induction cooktop assembly includes a first induction coil corresponding to a first heat zone of the induction cooktop assembly. The induction cooktop assembly further includes a second induction coil corresponding to a second heat zone of the induction cooktop assembly. The induction cooktop assembly further includes a circuit board disposed below the first and second induction coils. The induction cooktop assembly further includes a first set of electrical components electrically coupled with the circuit board and configured to control the first induction coil. The induction cooktop assembly further includes a second set of electrical components electrically coupled with the circuit board and configured to control the second induction coil. The first set of electrical components is nearer to the second induction coil than the second set of electrical components is to the second induction coil. The second set of electrical components is nearer to the first induction coil than the first set of electrical components is to the first induction coil.

According to another aspect of the present disclosure, the first and second sets of electrical components are disposed on a common substrate of a printed circuit board (PCB) disposed below the first and second induction coils.

According to another aspect of the present disclosure, the first set of electrical components includes a pair of first transistors for controlling electrical current through the first induction coil, and the second set of electrical components includes a pair of second transistors for controlling electrical current through the second induction coil.

According to another aspect of the present disclosure, the first set of electrical components includes first resonant capacitors for discharging electrical current through the first induction coil, and the second set of electrical components includes a pair of second transistors and a pair of second resonant capacitors for discharging electrical current through the second induction coil.

According to another aspect of the present disclosure, control circuitry is configured to selectively activate the pair of first transistors and the pair of second transistors to control current through the first induction coil and the second induction coil, respectively.

According to another aspect of the present disclosure, first and second sockets are disposed on the PCB and electrically coupled with the first and second sets of electrical components, respectively, wherein the first and second sockets are configured to receive electrical connectors electrically coupled with the first and second induction coils, respectively.

According to another aspect of the present disclosure, a support plate on which the first and second induction coils are disposed, wherein the support plate defines at least one aperture for receiving the electrical connectors.

According to another aspect of the present disclosure, the first induction coil is disposed adjacent a front of the induction cooktop assembly and the second induction coil is disposed adjacent to a back of the induction cooktop assembly, and wherein the second set of electrical components is disposed closer to the front than the back.

According to another aspect of the present disclosure, a cooking appliance includes a first induction coil corresponding to a first heat zone, a second induction coil corresponding to a second heat zone, a circuit board disposed below the first and second induction coils, a first set of electrical components electrically coupled with the circuit board and configured to control the first induction coil, and a second set of electrical components electrically coupled with the circuit board and configured to control the second induction coil, wherein the first set of electrical components is nearer to the second induction coil than the second set of electrical components is to the second induction coil, and wherein the second set of electrical components is nearer to the first induction coil than the first set of electrical components is to the first induction coil.

According to another aspect of the present disclosure, the first and second sets of electrical components are disposed on a common substrate of a printed circuit board (PCB) disposed below the first and second induction coils.

According to another aspect of the present disclosure, the first set of electrical components includes a pair of first transistors for controlling electrical current through the first induction coil, and the second set of electrical components includes a pair of second transistors for controlling electrical current through the second induction coil.

According to another aspect of the present disclosure, the first set of electrical components includes first resonant capacitors for discharging electrical current through the first induction coil, and the second set of electrical components includes a pair of second transistors and a pair of second resonant capacitors for discharging electrical current through the second induction coil.

According to another aspect of the present disclosure, control circuitry is configured to selectively activate the pair of first transistors and the pair of second transistors to control current through the first induction coil and the second induction coil, respectively.

According to another aspect of the present disclosure, first and second sockets are disposed on the PCB and electrically coupled with the first and second sets of electrical components, respectively, wherein the first and second sockets are configured to receive electrical connectors electrically coupled with the first and second induction coils, respectively.

According to another aspect of the present disclosure, a support plate on which the first and second induction coils are disposed, wherein the support plate defines at least one aperture for receiving the electrical connectors.

According to another aspect of the present disclosure, the first induction coil is disposed adjacent a front of the induction cooktop assembly and the second induction coil is disposed adjacent to a back of the induction cooktop assembly, and the second set of electrical components is disposed closer to the front than the back.

According to another aspect of the present disclosure, an induction cooktop assembly includes a cooktop surface that extends between a first end of the induction cooktop assembly to a second end of the cooktop assembly opposite the first end, a first induction coil corresponding to a first heat zone of the induction cooktop assembly, a second induction coil corresponding to a second heat zone of the induction cooktop assembly, a circuit board disposed below the first and second induction coils, a first set of electrical components electrically coupled with the circuit board and configured to control the first induction coil, and a second set of electrical components electrically coupled with the circuit board and configured to control the second induction coil, wherein the first set of electrical components is nearer to the second induction coil than the second set of electrical components is to the second induction coil, wherein the second set of electrical components is nearer to the first induction coil than the first set of electrical components is to the first induction coil, and wherein the first and second sets of electrical components are disposed on a common substrate of a printed circuit board (PCB) disposed below the first and second induction coils.

According to another aspect of the present disclosure, the first set of electrical components includes a pair of first transistors for controlling electrical current through the first induction coil, and the second set of electrical components includes a pair of second transistors for controlling electrical current through the second induction coil.

According to another aspect of the present disclosure, the first set of electrical components includes first resonant capacitors for discharging electrical current through the first induction coil, and the second set of electrical components includes a pair of second transistors and a pair of second resonant capacitors for discharging electrical current through the second induction coil.

According to another aspect of the present disclosure, control circuitry is configured to selectively activate the pair of first transistors and the pair of second transistors to control current through the first induction coil and the second induction coil, respectively.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An induction cooktop assembly, comprising:
a cooktop surface that extends between a first end of the induction cooktop assembly to a second end of the cooktop assembly opposite the first end;
a first induction coil corresponding to a first heat zone of the induction cooktop assembly;
a second induction coil corresponding to a second heat zone of the induction cooktop assembly;
a circuit board disposed below the first and second induction coils;
a first set of electrical components electrically coupled with the circuit board and configured to control the first induction coil; and
a second set of electrical components electrically coupled with the circuit board and configured to control the second induction coil, wherein the first set of electrical components is nearer to the second induction coil than the second set of electrical components is to the second induction coil, and wherein the second set of electrical components is nearer to the first induction coil than the first set of electrical components is to the first induction coil.

2. The induction cooktop assembly of claim 1, wherein the first and second sets of electrical components are disposed on a common substrate of a printed circuit board (PCB) disposed below the first and second induction coils.

3. The induction cooktop assembly of claim 1, wherein the first set of electrical components includes a pair of first transistors for controlling electrical current through the first induction coil, and wherein the second set of electrical components includes a pair of second transistors for controlling electrical current through the second induction coil.

4. The induction cooktop assembly of claim 3, wherein the first set of electrical components includes first resonant capacitors for discharging electrical current through the first induction coil, and wherein the second set of electrical components includes a pair of second transistors and a pair of second resonant capacitors for discharging electrical current through the second induction coil.

5. The induction cooktop assembly of claim 3, further comprising:
control circuitry configured to selectively activate the pair of first transistors and the pair of second transistors to control current through the first induction coil and the second induction coil, respectively.

6. The induction cooktop assembly of claim 2, further comprising:
first and second sockets disposed on the PCB and electrically coupled with the first and second sets of electrical components, respectively, wherein the first and second sockets are configured to receive electrical connectors electrically coupled with the first and second induction coils, respectively.

7. The induction cooktop assembly of claim 4, further comprising:
a support plate on which the first and second induction coils are disposed, wherein the support plate defines at least one aperture for receiving the electrical connectors.

8. The induction cooktop assembly of claim 1, wherein the first induction coil is disposed adjacent a front of said induction cooktop assembly and the second induction coil is disposed adjacent to a back of said induction cooktop assembly, and wherein the second set of electrical components is disposed closer to the front than the back.

9. A cooking appliance, comprising:
a first induction coil corresponding to a first heat zone;
a second induction coil corresponding to a second heat zone;
a circuit board disposed below the first and second induction coils;
a first set of electrical components electrically coupled with the circuit board and configured to control the first induction coil; and
a second set of electrical components electrically coupled with the circuit board and configured to control the second induction coil, wherein the first set of electrical components is nearer to the second induction coil than the second set of electrical components is to the second induction coil, and wherein the second set of electrical components is nearer to the first induction coil than the first set of electrical components is to the first induction coil.

10. The cooking appliance of claim 9, wherein the first and second sets of electrical components are disposed on a common substrate of a printed circuit board (PCB) disposed below the first and second induction coils.

11. The cooking appliance of claim 9, wherein the first set of electrical components includes a pair of first transistors for controlling electrical current through the first induction coil, and wherein the second set of electrical components includes a pair of second transistors for controlling electrical current through the second induction coil.

12. The cooking appliance of claim 11, wherein the first set of electrical components includes first resonant capacitors for discharging electrical current through the first induction coil, and wherein the second set of electrical components includes a pair of second transistors and a pair of second resonant capacitors for discharging electrical current through the second induction coil.

13. The cooking appliance of claim 11, further comprising:
control circuitry configured to selectively activate the pair of first transistors and the pair of second transistors to control current through the first induction coil and the second induction coil, respectively.

14. The cooking appliance of claim 9, further comprising:
first and second sockets disposed on the PCB and electrically coupled with the first and second sets of electrical components, respectively, wherein the first and second sockets are configured to receive electrical connectors electrically coupled with the first and second induction coils, respectively.

15. The cooking appliance of claim 14, further comprising:
a support plate on which the first and second induction coils are disposed, wherein the support plate defines at least one aperture for receiving the electrical connectors.

16. The cooking appliance of claim 9, wherein the first induction coil is disposed adjacent a front of said induction cooktop assembly and the second induction coil is disposed adjacent to a back of said induction cooktop assembly, and wherein the second set of electrical components is disposed closer to the front than the back.

17. An induction cooktop assembly, comprising:
a cooktop surface that extends between a first end of the induction cooktop assembly to a second end of the cooktop assembly opposite the first end;
a first induction coil corresponding to a first heat zone of the induction cooktop assembly;
a second induction coil corresponding to a second heat zone of the induction cooktop assembly;
a circuit board disposed below the first and second induction coils;
a first set of electrical components electrically coupled with the circuit board and configured to control the first induction coil; and
a second set of electrical components electrically coupled with the circuit board and configured to control the second induction coil, wherein the first set of electrical components is nearer to the second induction coil than the second set of electrical components is to the second induction coil, wherein the second set of electrical components is nearer to the first induction coil than the first set of electrical components is to the first induction coil, and wherein the first and second sets of electrical components are disposed on a common substrate of a printed circuit board (PCB) disposed below the first and second induction coils.

18. The induction cooktop assembly of claim 17, wherein the first set of electrical components includes a pair of first transistors for controlling electrical current through the first induction coil, and wherein the second set of electrical components includes a pair of second transistors for controlling electrical current through the second induction coil.

19. The induction cooktop assembly of claim 18, wherein the first set of electrical components includes first resonant capacitors for discharging electrical current through the first induction coil, and wherein the second set of electrical components includes a pair of second transistors and a pair of second resonant capacitors for discharging electrical current through the second induction coil.

20. The induction cooktop assembly of claim 19, further comprising:
control circuitry configured to selectively activate the pair of first transistors and the pair of second transistors to control current through the first induction coil and the second induction coil, respectively.
